(19) United States
(12) Patent Application Publication
(10) Pub. No.: US 2025/0102005 A1
(43) Pub. Date: Mar. 27, 2025

(54) Improved Fastening Clip

(71) Applicant: Illinois Tool Works Inc., Glenview, IL (US)

(72) Inventor: Òscar RIBES MARTÍ, Sabadell (ES)

(21) Appl. No.: 18/885,067

(22) Filed: Sep. 13, 2024

(30) Foreign Application Priority Data
Sep. 25, 2023 (EP) 23199530.9
Sep. 3, 2024 (DE) 2024 125 190.5

(51) Int. Cl. F16B 21/07; B60R 7/08; B60R 21/20; F16B 2/24

(52) U.S. Cl. CPC F16B 21/075; B60R 7/08; B60R 21/20; F16B 2/245

(57) ABSTRACT

The present disclosure provides a fastening clip for mounting a component, such as an airbag or a luggage ring, to a support structure. The fastening clip includes a head portion having a plate arranged to retain a part of the component between the plate and the support structure during use. The fastening clip also includes a body portion, extending from the head portion to a lower end region along a longitudinal axis. The body portion includes at least one elastically deflectable retaining member projecting laterally from said lower end region of said body portion, to fixingly engage a surface of the support structure when inserted into an orifice of the support structure. The fastening clip also includes at least one resilient spring element extending from the head portion to contact an opposite side of the support structure to the at least one elastically deflectable retaining member in use, and to bias the at least one elastically deflectable retaining member into contact with the support structure. Each of the at least one resilient spring elements comprises: a transverse portion extending in a direction across the longitudinal axis; and an intermediate portion extending from an end of the transverse portion between the transverse portion and the plate, the intermediate portion being disposed to engage the part of the component when the resilient spring element is deflected towards the plate during use.

### RELATED APPLICATIONS

The present application claims the benefit of European Patent Application No. 23199530.9, filed Sep. 25, 2023, and German Patent Application No. 2024 125 190.5, filed Sep. 3, 2024, each titled “Improved Fastening Clip,” the contents of which are hereby incorporated by reference.

### BACKGROUND

In the automotive industry, fastening clips are used to mount components, structures or panels to the frame of a vehicle. Airbags are safety devices that are increasingly being used in the motor industry and which, in combination with other safety components, such as seatbelts, help to reduce fatal accidents in the case of collisions. The tests to which the vehicles have been subjected, as well as, mortality statistics, have clearly demonstrated that the use of airbags can considerably improve the safety of automobile occupants and, when combined with other forms of passive safety, such as seat belts, significantly (by about 30%) reduce mortality in the case of serious accidents.

Today, manufacturers produce frontal airbags, which are designed to protect the driver and/or passenger in the event of a head-on collision and, considering their positions, lateral airbags that are installed behind the posts and/or in the sides of the vehicle seats, along with curtain airbags.

Airbags of the curtain type are usually located in the part close to the roof on the sides of the automobile, e.g. situated above the front and rear doors. Such airbags have very rigorous requirements with regard to the goals set for them and the technical challenges that have to be overcome. Typical challenges may be their location in the vehicle and the way they are fastened, required deployment time and the time that the airbag is required to remain inflated. Other challenges may come from the fact that there is only a short distance between the body and the occupant and that there is little vehicle material between the occupant and an impacting vehicle. For example, it is essential that airbags are deployed in a fraction of a second, giving rise to an enormous snatch force on their attachment components, which then suffer the consequences of that impact.

There is also a desire to increase the pull-out force which fastening clips, such as clip 100, can withstand in order to prevent undesired removal when a load is applied to the luggage ring and in order to prevent unwanted damage to the panel to which the luggage ring is attached.

It is an object of the present disclosure to provide an improved fastening clip, suitable for attaching airbags, such as side-impact or curtain airbags, or luggage rings to a vehicle structure, that is robust and efficient, as well as, ergonomic and safe to minimize the risk of accidental removal of the fastening clip and/or damage to panels in which the fastening clip is inserted.

### SUMMARY

The present disclosure relates generally to a fastening clip, substantially as illustrated by and described in connection with at least one of the figures, as set forth more completely in the claims.

### BRIEF DESCRIPTION OF THE DRAWINGS

The foregoing and other objects, features, and advantages of the devices, systems, and methods described herein will be apparent from the following description of particular examples thereof, as illustrated in the accompanying figures, where like or similar reference numbers refer to like or similar structures. The figures are not necessarily to scale, emphasis instead being placed upon illustrating the principles of the devices, systems, and methods described herein.

FIG. 1 is a perspective illustration of a fastening clip used for attaching components, such as airbags, to a vehicle chassis.

FIG. 2 is a perspective illustration of another fastening clip used for attaching components, such as luggage rings, to a vehicle chassis.

FIG. 3 shows a perspective view of an example aspect of the fastening clip of the present disclosure.

FIG. 4 is a perspective cross-section view of the fastening clip shown in FIG. 3.

FIG. 5 is a front view of the fastening clip shown in FIG. 3.

FIG. 6 is a partial front view of the fastening clip show in FIG. 3.

FIG. 7 is a side view of the fastening clip shown in FIG. 3.

FIG. 8 is a bottom view of the fastening clip shown in FIG. 3.

FIG. 9 is a top view of the fastening clip shown in FIG. 3.

FIG. 10 is a side view of the fastening clip shown in FIG. 3, with the spring elements in a first position.

FIG. 11 is a side view of the fastening clip shown in FIG. 3, with the spring elements in a second position.

### DETAILED DESCRIPTION

The described example aspects relate to fastening clips suitable for securing paraphernalia and accessories. The aspects of the disclosure are normally applied in vehicles. Although the disclosure is described with respect to vehicles, the disclosure is not restricted to vehicles altogether, but may also be used in other structures requiring attachment of accessories or peripheral components to a structure.

Certain terminology is used in the following description for convenience only and is not limiting. The words ‘right’, ‘left’, ‘lower’, ‘upper’, ‘front’, ‘rear’, ‘upward’, ‘down’ and ‘downward’ designate directions in the drawings to which reference is made and are with respect to the described component when assembled and mounted. The words ‘inner’, ‘inwardly’ and ‘outer’, ‘outwardly’ refer to directions toward and away from, respectively, a designated centerline or a geometric center of an element being described (e.g. central axis), the particular meaning being readily apparent from the context of the description. Further, as used herein, the terms ‘connected’, ‘attached’, ‘coupled’, ‘mounted’ are intended to include direct connections between two members without any other members interposed therebetween, as well as, indirect connections between members in which one or more other members are interposed therebetween. The terminology includes the words specifically mentioned above, derivatives thereof, and words of similar import. Further, unless otherwise specified, the use of ordinal adjectives, such as, “first”, “second”, “third” etc. merely indicate that different instances of like objects are being referred to and are not intended to imply that the objects so described must be in a given sequence, either temporally, spatially, in ranking or in any other manner.

The present disclosure generally relates to the field of fasteners and in particular, to the field of fastening clips for attaching one or more components, such as airbag devices or luggage rings, to an external structure. More specifically, the present disclosure relates to an improved fastening clip for attaching a side-impact airbag or curtain-type airbag or a luggage ring to a vehicle structure.

According to the present disclosure there is provided a fastening clip for mounting a component, such as an airbag or a luggage ring, to a support structure, the fastening clip comprising: a head portion having a plate arranged to retain a part of the component between the plate and the support structure during use, a body portion, extending from the head portion to a lower end region along a longitudinal axis, wherein the body portion comprises at least one elastically deflectable retaining member projecting laterally from said lower end region of said body portion, to fixingly engage a surface of the support structure when inserted into an orifice of the support structure; and at least one resilient spring element extending from the head portion to contact an opposite side of the support structure to the at least one elastically deflectable retaining member in use, and to bias the at least one elastically deflectable retaining member into contact with the support structure, wherein each of the at least one resilient spring elements comprises: a transverse portion extending in a direction across the longitudinal axis; and an intermediate portion extending from an end of the transverse portion between the transverse portion and the plate, the intermediate portion being disposed to engage the part of the component when the resilient spring element is deflected towards the plate during use.

Accordingly, in use when the fastening clip is mounting the component to the support structure, the resilient spring element is compressed between the component and the support structure and the intermediate portion presses against the component. Advantageously, this may help to resist rotation of the component relative to the fastening clip.

In examples, each of the at least one intermediate portions comprises a tab portion extending towards the transverse portion to contact the transverse portion and limit deflection of the intermediate portion towards the transverse portion during use.

In examples, each of the at least one resilient spring elements comprises a longitudinal portion extending from the head portion in a direction having a longitudinal component, and wherein the transverse portion extends from the longitudinal portion.

In examples, the longitudinal portion extends in a direction substantially parallel to the longitudinal axis.

In examples, the longitudinal portion has a length in the longitudinal direction, the length being configured such that when the fastening clip is affixed to the opening in the support structure the transverse portion lies substantially parallel to the support structure in a deflected state.

In examples, the part of the component is rotatable within the fastening clip.

In examples, the component comprises a loop, and wherein the part of the component comprises a part of the loop.

According to the present disclosure there is also provided a fastening clip for mounting a component, such as an airbag or a luggage ring, to a support structure, the fastening clip comprising: a head portion and a body portion extending from the head portion to a lower end region along a longitudinal axis, wherein the body portion comprises at least one elastically deflectable retaining member projecting laterally from said lower end region of said body portion to fixingly engage a surface of the support structure when inserted into an orifice of the support structure; and at least one resilient spring element extending from the head portion to contact an opposite side of the support structure to the at least one elastically deflectable retaining member in use, and to bias the at least one elastically deflectable retaining member into contact with the support structure, wherein each of the at least one resilient spring elements comprises: a longitudinal portion extending from the head portion in a direction having a longitudinal component, and a transverse portion extending from the longitudinal portion across the longitudinal axis, and wherein the longitudinal portion has a length in the longitudinal direction, the length being configured such that when the fastening clip is affixed to the opening in the support structure the transverse portion lies substantially parallel to the support structure in a deflected state.

Advantageously, the parallel arrangement of the transverse portion of the resilient spring element and the support structure provides improved stability. In particular, the transverse portion presses evenly against the support structure along its length, providing improved resistance to twisting or tilting.

In examples, the longitudinal portion extends in a direction substantially parallel to the longitudinal axis.

In examples, each of the at least one resilient spring elements further comprises an intermediate portion extending from the transverse portion between the transverse portion and the head portion.

In examples, the intermediate portion comprises a tab portion extending towards the transverse portion to contact the transverse portion and limit deflection of the intermediate portion towards the transverse portion during use.

In examples, the head portion comprises a plate adapted to retain a part of the component between the plate and the support structure during use, and wherein the intermediate portion is arranged to engage the part of the component when the at least one resilient spring element is deflected during use.

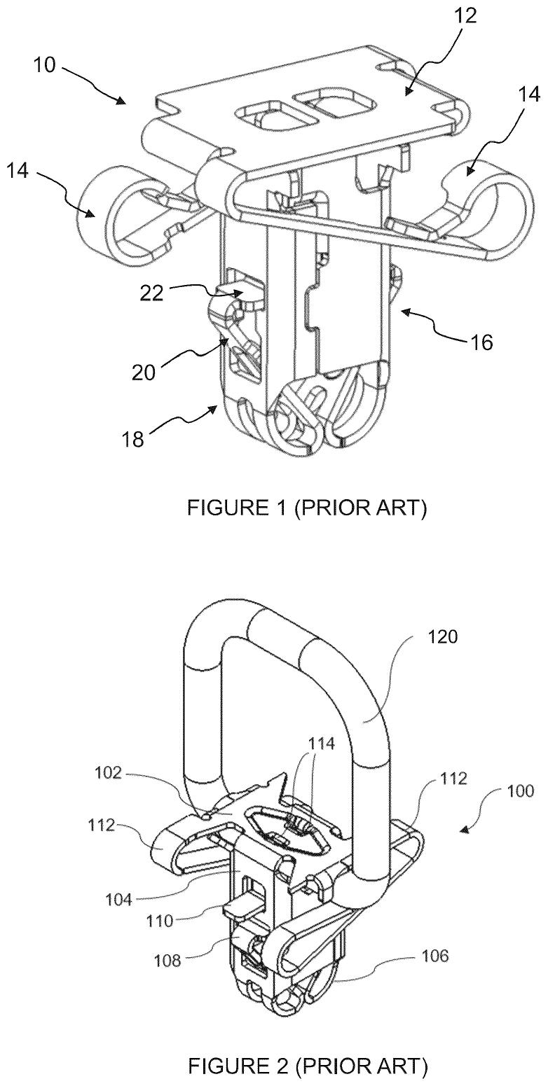

FIG. 1 illustrates a typical clip 10 used for the attachment of airbags, such as side-impact or curtain airbags. The clip 10 has a head portion 12 from which extend flexible elements, such as spring elements 14, that, during use, are adapted to bear against an outer surface of an attachment panel when the clip 10 enters an aperture of the panel. The clip 10 also has a body portion 16, including descending tangs 18 which give rise to different structures of the clip 10, such as, for example, side limbs 20 having surfaces 22 configured to bear against an inner surface of the panel in such a way that the supporting surfaces 22 and those provided by the flexible spring elements 14 engage the attachment panel on both sides, i.e. in the form of a sandwich, thus enabling the clip 10 to be fixedly supported on the panel. The clip 10 may be formed from a single folded and punched laminar surface, to form a three-dimensional body made from, for example, metal, such as, carbon steel.

Since an airbag deploys in a few thousandths of a second, reaching an expansion speed that is approximately equivalent to 300 Km/h, the forces involved in the firing of the airbag are enormous and act on the support elements of the mechanism and thus on the fastening clips of the airbags. The shaking involved in the expansion of the airbag exerts a heavy outward traction force on the panel that acts directly on the above-mentioned clips which must, however, withstand it without damaging the ball/curtain or the panel to which they are attached. There is, therefore, a desire to increase the pull-out force which fastening clips, such as clip 10, can withstand. There is also a desire to reduce the risk of elements of the clips, e.g. edges, causing damage to the panel to which it is attached.

Another type of fastening clip for use in a storage compartment of a vehicle, is embedded to a base panel or a side panel of the storage compartment. Such a fastening clip is located at a fixed point, or more often, multiple fixed points, of the storage compartment. The fastening clip(s) is connected to a luggage ring, onto which loose objects such as shopping bags or items are attached so that they do not move around the storage compartment when the vehicle is in motion.

An example of such a fastener clip 100, to which a luggage ring 120 is connected, is shown in FIG. 2. The body 104 of the fastening clip 100 is integrally formed with a head 102. The head 102 has an opening on its top surface, on which are provided mechanical stops 114 on opposite sides. These mechanical stops 114 act as a guide to secure the luggage ring 120 to the fastening clip 100. The head 102 of the fastening clip 100 has holding arms 112 integral with and extending from opposite corners. The holding arms 112 are in contact with and partially surround the luggage ring 120 when the luggage ring 120 is secured to the fastening clip 100. This allows the luggage ring 120 to be maintained in a desired position by friction during use, such as in the upstanding position shown in FIG. 2. The body 104 of the fastening clip 100 is provided with openings on the sides. The openings provide access for parts of the fastening clip 100 to extend through from the inside of the body 104 through to the outside. More specifically, the fastening clip 100 is provided with a pair of oppositely protruding resilient arms 110 extending through a respective pair of opposite upper openings in the body 104. The resilient arms 110 laterally protrude in a direction parallel to an upper surface of the head 102. The fastening clip 100 is also provided with a pair of oppositely protruding shoulders 108 extending through a respective pair of opposite lower openings in the body 104. The resilient arm 110 and shoulder 108 on each side are integrally formed. At an end away from the head 102, the fastening clip 100 is provided with legs 106 for insertion into a panel structure, in order to secure the fastening clip 100 to the support structure.

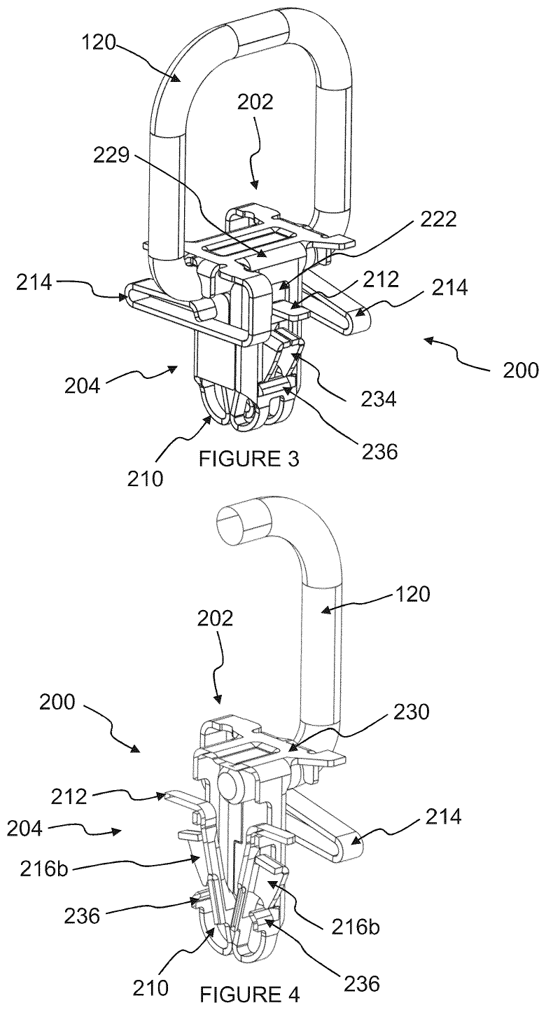

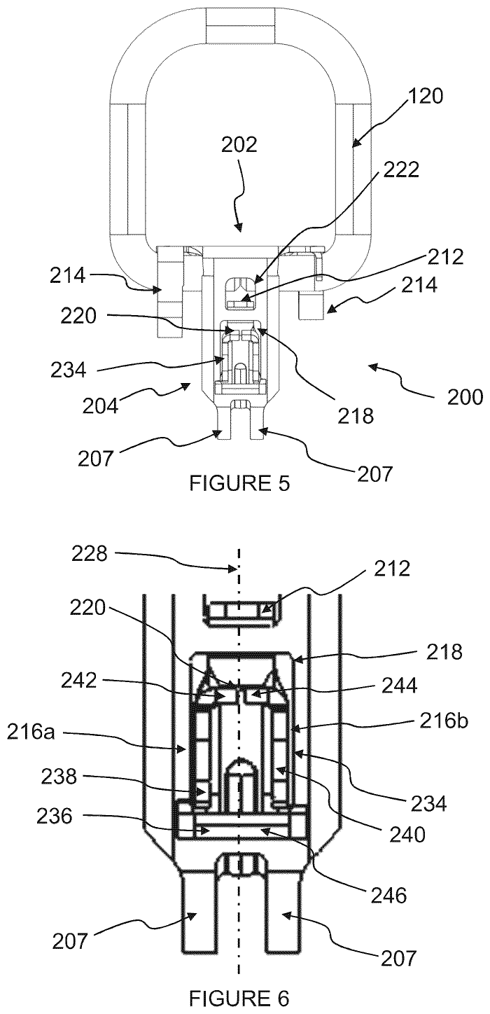

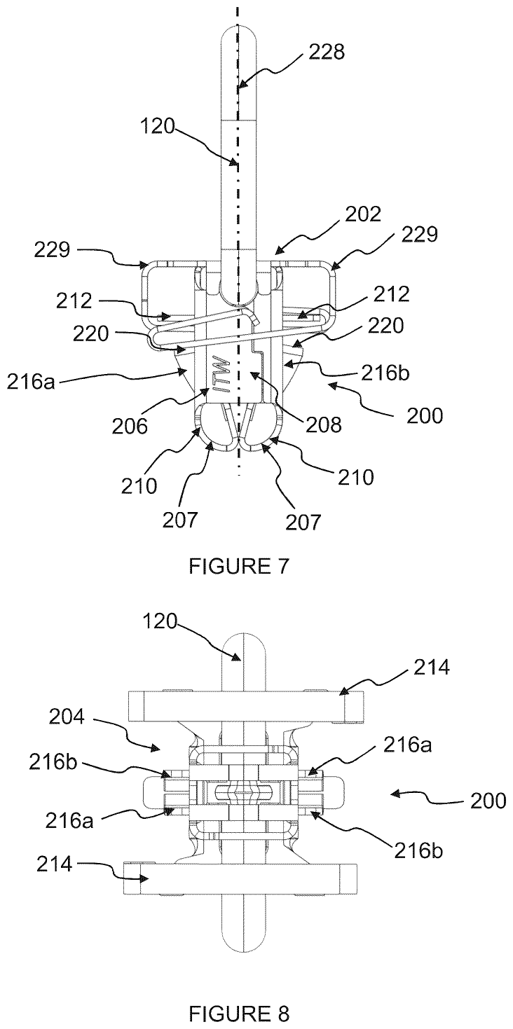

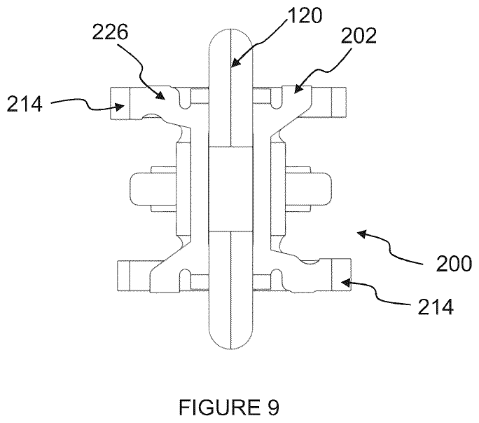

Referring now to FIGS. 3 to 11, an example aspect of a fastening clip 200 of the present disclosure is shown. The fastening clip 200 is connected to a luggage ring 120. The fastening clip 200 is of the type formed by a pre-cut 2D blank (patterned and cut for folding). The fastening clip 200 has a body, or body portion, 204 which is integrally formed with a head, or head portion, 202.

Fastening clips 200 such as those according to this disclosure are inserted into an opening made in the surface of an attachment panel (not shown). This surface effectively divides the clip 200 into an upper outer part, i.e. the head portion 202, which is not inserted into the opening and an inner lower part, i.e. the body portion 204, which is inserted into the opening. The upper part or head portion 202 of the clip 200 corresponds to the outer part and the lower part or body portion 204 of the clip 200 corresponds to the inner part. Likewise, the ascending direction is from the inner part to the outer part (lower to upper) and the descending direction is from the outer part to the inner part (upper to lower).

The body 204 comprises elastically deflectable retaining member in the form of descending tangs 210, which give rise to different structures of the clip, such as, for example, legs 207, resilient arms 212, limbs 234 and mechanical stops 236. In examples, the limbs 234 are U-shaped limbs.

The body 204 is formed by a box 206 that is formed by the union of two surfaces which are approximately “U”-shaped in transverse cross-section, being attached by one of their ends, and the attachment being strengthened by respective tabs 208 produced by division of the portions of the connecting part forming opposite surfaces. As may be seen from the attached figures, tabs 208 which are located within box 206 may have nails (not shown) that are shaped to engage in the openings provide in box 206. The body 204 has a central, or longitudinal, axis 228.

The descending tangs 210 have an inclination towards the central, or longitudinal, axis 228 of the clip and extend downwards from box 206 towards the center of clip 200 to then form loops or legs 207 and extend away from the center of the clip 200. In the preferred construction of the disclosure and as illustrated in the drawings, the loops, or legs 207, of tangs 210 may be in contact with each other. This contact provides strength to the clip against pull-out forces.

The descending tangs 210 also give rise to a pair of oppositely protruding resilient arms 212 which are configured to emerge from the inner part of box 206 towards the exterior of the same, through a respective pair of openings or windows 222 made in the surface of the box 206. The resilient arms 212 laterally protrude in a direction parallel to an upper surface of the head 202.

A limb 234 also extends from each of the descending tangs 210. With particular reference to FIG. 6, each limb 234 includes a first portion 238 extending in a generally longitudinal plane relative to said longitudinal axis 228, a second portion 240 spaced apart from the first portion 238 and extending in a generally longitudinal plane relative to said longitudinal axis 228 and a third portion 242 extending from the first portion 238 in a transverse plane relative to said longitudinal axis 228. The first portion 238 and the third portion 242 define a first L-shaped limb portion 216a. In the illustrated aspect, the limb 234 also has a fourth portion 244. The fourth portion 244 extends from the second portion 240 in a transverse plane relative to said longitudinal axis 228. The second portion 240 and the fourth portion 244 define a second L-shaped limb portion 216b. The third portion 242 and the fourth portion 244 lie in the same transverse plane. In other words, the transverse plane of the third portion 242 and the transverse plane of the fourth portion 244 is a common plane.

The limbs 234 are also configured to emerge from the inner part of box 206 towards the exterior of the box 206, through a respective opening or window 218 made in its surface. In use, the first and second L-shaped limb portions 216a, 216b face each other to form a U-shaped limb 234. The third portion 242 and the fourth portion 244 together define a bearing surface 220, against which the support structure bears in use. In other words, the base of the limb 234 defines the bearing surface 220.

The descending tangs 210 also give rise to a pair of mechanical stops, or stop members 236. Each of the stop members 236 includes a sloped wall 246 which extends from the lower end region of the body toward the respective opening or window 218 in the body 204. The stop members 236 are positioned within the box 206 and are not configured to emerge from the inner part of box 206.

The head 202 includes a substantially rectangularly shaped plate 226 with a flat upper surface. The plate 226 is arranged transverse to the longitudinal axis 228 of the body portion 204. Resilient spring elements 214 (i.e. flexion legs) extend from the plate 226 to contact the attachment panel.

As illustrated, a central portion 230 of two opposing protruding side edges of the plate 226 is folded towards and merged into a respective side of the body portion 204 (i.e. forming the box 206), to form a rounded side edge (e.g. a closed or open hem).

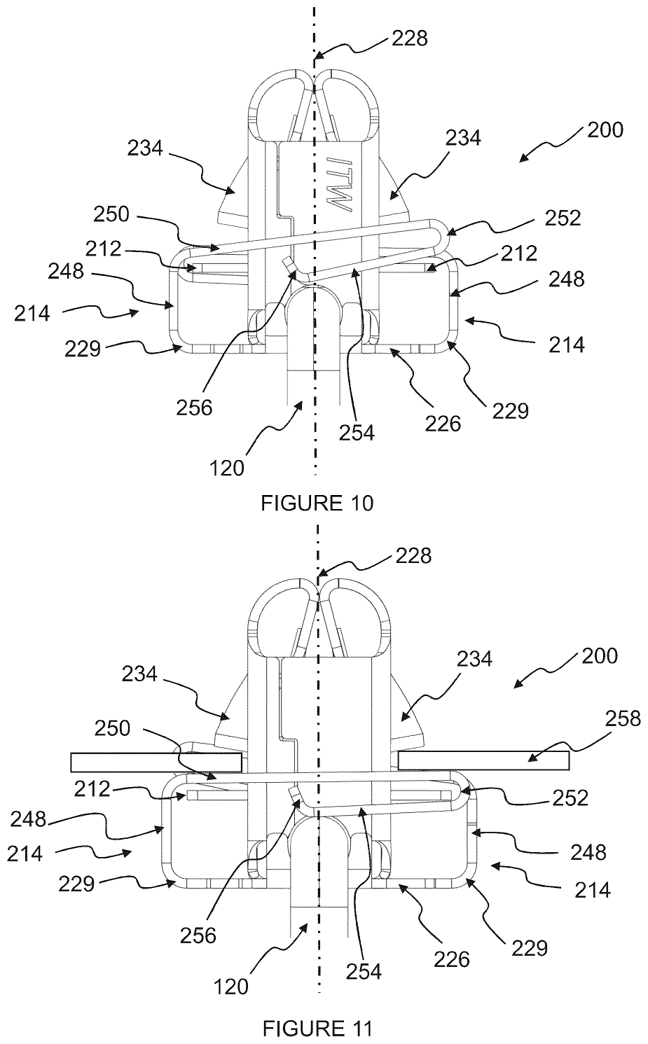

There are two resilient spring elements 214 arranged on opposite sides of the plate 226. As shown most clearly in FIGS. 10 and 11, the resilient spring elements 214 extend from opposite ends of the plate 226 in a direction parallel with the body tabs 208 (parallel to the longitudinal axis 228 and perpendicular to the plate 226). The resilient spring elements 214 are oppositely oriented and rotationally symmetrical about the longitudinal axis 228. The resilient spring elements 214 are folded from the plane of the plate 226 at side edges 229 of the plate 226. The side edges 229 form approximately 90 degree bends. The resilient spring elements 214 comprise longitudinal portions 248 extending from the side edges 229 in a longitudinal direction towards the limbs 234. At a position proximate to the resilient arms 212 and spaced slightly from the plane of the resilient arms 212 towards the limbs 234, the resilient spring elements 214 are bent into transverse portions 250 that extend substantially transversely to the longitudinal axis towards an opposite side of the fastening clip 200. As shown in FIG. 10, in a relaxed condition (before assembly with the attachment panel and without an external force applied) the transverse portions 250 are angled with respect to the plate 226, towards the limbs 234. At ends of the transverse portions 250 the resilient spring elements 214 include a bend 252 and an intermediate portion 254 extending from the bend 252. The bend 252 may be a U-bend and may have an angle of between about 120 degrees and about 180 degrees. The intermediate portion 254 is located between the plate 226 and the transverse portion 250.

FIG. 11 shows the fastening clip 200 when assembled with an attachment panel 258.

The attachment panel 258 is shown in sectional view with the fastening clip 200 inserted into an opening in the attachment panel 258. As shown, as the resilient arms 212 are deflected towards the plate 226 and the intermediate portions 254 engage the luggage ring 120, particularly the part of the luggage ring 120 that is received underneath the plate 226. As the luggage ring 120 is rotatable within the fastening clip 200, the engagement of the intermediate portions 254 on the luggage ring 120 will resist rotation of the luggage ring 120. Therefore, the engagement of the intermediate portions 254 and the luggage ring 120 will act to prevent rattling of the luggage ring 120. In addition, the intermediate portions 254 still allow rotation of the luggage ring 120 by a user and act to prevent rotation of the luggage ring 120 under its own weight. In this way the luggage ring 120 will remain in a position determined by the user, making it easier to use.

As also shown in FIGS. 10 and 11, ends of the intermediate portions 254 comprise tab portions 256 that are bent relative to the intermediate portions 254 towards the transverse portions 250. The tab portions 256 are non-perpendicular to the intermediate portions 254.

As shown in FIG. 11, when the fastening clip 200 is assembled with the attachment panel 258 the resilient spring elements 214, in particular the transverse portions 250, contact a surface of the attachment panel 258 and are deflected towards the plate 226 to exert a force holding the limbs 234 (in particular the bearing surfaces 220) against the opposite side of the attachment panel 258. The resilient spring elements 214 thereby reduce movement and play of the fastening clip 200 within the opening in the attachment panel 258. Once the fastening clip 200 has been assembled with the attachment panel 258 the resilient spring elements 214 are in the deflected position shown in FIG. 11. In this position the transverse portions 250 are deflected towards the plate 226 and the intermediate portions 254 have been pushed against the luggage ring 120 as described above. Accordingly, the bends 252 are further bent and the intermediate portions 254 are deflected towards the transverse portions 250. In this position the attachment panel 258 is sandwiched between the limbs 234 and the resilient spring elements 214.

Advantageously, as shown in FIG. 11, in this position the transverse portions 250 are approximately parallel with the attachment panel 258. This allows the resilient spring elements 214 to provide improved stability because the force urging the limbs 234 against the attachment panel 258 is applied over the length of the transverse portions 250 and so there is no torsion generated by the resilient spring elements 214. In addition, the resilient spring elements 214 can better resist any twisting or tilting of the fastening clip 200 relative to the attachment panel 258 because, together, the two transverse portions 250 contact the attachment panel 258 across the width of the fastening clip 200 along two opposite sides so resist any twisting or tilting.

It will be appreciated that the longitudinal length of the longitudinal portions 248 is selected based on the thickness of the attachment panel 258 and thus the distance between the limbs 234 and the surface of the attachment panel 258 facing the head 202 (and engaged by the resilient spring elements 214). In this way, when the fastening clip 200 is assembled with the attachment panel 258 the transverse portions 250 can be approximately parallel to the attachment panel 258.

Additionally, as shown in FIG. 11, when the fastening clip 200 is assembled with the attachment panel 258 the tab portions 256 are proximate to, or in contact with, the transverse portions 250. The tab portions 256 thereby prevent further deflection of the transverse portions 250 towards the plate 226 (and vice versa) and therefore reduce potential movement of the fastening clip 200 relative to the attachment panel 258 when an external force is applied.

Specifically, as shown in FIG. 11, the arrangement of the luggage ring 120, the intermediate portions 254, the tab portions 256, and the transverse portions 250 creates a block against longitudinal movement of the fastening clip 200 relative to the attachment panel 258. This reduces play in the fastening clip 200 and reduces the risk of the fastening clip 200 being twisted or pulled out. As there are two resilient spring elements 214 there is a block formed on both sides of the fastening clip 200. The blocks, combined with the parallel contact between the transverse portions 250 and the attachment panel 258, also helps the fastening clip 200 to resist twisting or tilting relative to the attachment panel 258.

In addition, the non-perpendicular angle between the tab portions 256 and the transverse portions 250 in the position shown in FIG. 11 also creates additional resilience, allowing some further deformation to occur if needed, but only with high force. Therefore, when a large force is applied to the fastening clip 200 the tab portions 256 may be subject to additional bending.

The clip 200 may be formed from a single laminar surface (i.e. a sheet material or blank) that is cut and punched in a unique way, to allow forming a three-dimensional aspect of the clip 200 by simply folding respective cut or punched portions of the sheet material at predetermined fold lines. In particular, the laminar surface (i.e. sheet material or blank) may be a sheet metal blank comprising predetermined cuts, bends and apertures that when folded form the specific parts and portions of the three-dimensional clip 200. The sheet metal material may be cut, punched, stamped or bent utilising suitable tooling (e.g. press, drills, laser cutting etc.).

The laminar surface or sheet metal blank may be made from a metal, such as, for example, carbon steel which has been heat treated to impart improved strength qualities to it. Further, clip 200 may undergo treatment to prevent corrosion and/or receive a suitable coating in order to improve its service life and wear in relation to dust, moisture and other elements which might attack the clip 200.

During assembly, the user simply pushes the fastening clip 200 into the mounting aperture (not shown) of the attachment panel (not shown) thus fixingly engaging the resilient arms 212 within an inner surface of the attachment panel (not shown). The legs 207 are inserted into the aperture (not shown). In order to hold the fastening clip 200 in place inside the panel, the resilient arms 212 and the limbs 234 are elastically and resiliently biased outwards. When the legs 207 of the fastening clip 200 are inserted into the panel opening, a force is exerted onto the limbs 234 and resilient arms 212 to urge them inwards. When the limbs 234 and resilient arms 212 deform inwardly, the fastening clip 200 can fit through the opening of the panel. After the limbs 234 and resilient arms 212 are inserted through and clear the opening of the panel, force is no longer exerted onto these components by the panel. The limbs 234 and resilient arms 212 bias back outward beyond the width of the opening, holding the fastening clip in place and preventing removal.

The panel is thus sandwiched between the bearing surfaces 220 of the limbs 234 and the spring elements 214.

If removal of the fastening clip 200 is required, a user can push the resilient arms 212 inward. This results in the limbs 234 being pulled inward (toward the inside of the box 206) and thus the fastening clip 200 can be pulled through the opening in the panel and removed.

The arrangement of the limbs 234 has been found to increase the force, e.g. the pull-out force, required to remove the fastening clip 200 from the aperture or opening in the panel without using the resilient arms 212 (i.e. unwanted or undesirable removal of the fastening clip 200).

The stop member 236 limits or restricts downward movement of the limbs 234. The arrangement of the stop member 236 has advantageously been found to increase the pull-out force of the fastening clip without hindering insertion of the fastening clip into an aperture in a panel.

While the present method and/or system has been described with reference to certain implementations, it will be understood by those skilled in the art that various changes may be made and equivalents may be substituted without departing from the scope of the present method and/or system. In addition, many modifications may be made to adapt a particular situation or material to the teachings of the present disclosure without departing from its scope. For example, block and/or components of disclosed examples may be combined, divided, re-arranged, and/or otherwise modified. Therefore, the present method and/or system are not limited to the particular implementations disclosed. Instead, the present method and/or system will include all implementations falling within the scope of the appended claims, both literally and under the doctrine of equivalents.

What is claimed is:

1. A fastening clip for mounting a component, such as an airbag or a luggage ring, to a support structure, the fastening clip comprising:
a head portion having a plate arranged to retain a part of the component between the plate and the support structure during use,
a body portion, extending from the head portion to a lower end region along a longitudinal axis, wherein the body portion comprises at least one elastically deflectable retaining member projecting laterally from said lower end region of said body portion, to fixingly engage a surface of the support structure when inserted into an orifice of the support structure; and
at least one resilient spring element extending from the head portion to contact an opposite side of the support structure to the at least one elastically deflectable retaining member in use, and to bias the at least one elastically deflectable retaining member into contact with the support structure,
wherein each of the at least one resilient spring elements comprises: a transverse portion extending in a direction across the longitudinal axis; and an intermediate portion extending from an end of the transverse portion between the transverse portion and the plate, the intermediate portion being disposed to engage the part of the component when the resilient spring element is deflected towards the plate during use.

2. The fastening clip of claim 1, wherein each of the at least one intermediate portions comprises a tab portion extending towards the transverse portion to contact the transverse portion and limit deflection of the intermediate portion towards the transverse portion during use.

3. The fastening clip of claim 2, wherein each of the at least one resilient spring elements comprises a longitudinal portion extending from the head portion in a direction having a longitudinal component, and wherein the transverse portion extends from the longitudinal portion, and wherein the longitudinal portion extends in a direction substantially parallel to the longitudinal axis.

4. The fastening clip of claim 3, wherein the longitudinal portion has a length in the longitudinal direction, the length being configured such that when the fastening clip is affixed to the opening in the support structure the transverse portion lies substantially parallel to the support structure in a deflected state.

5. The fastening clip of claim 1, wherein the part of the component is rotatable within the fastening clip, and wherein the component comprises a loop, and wherein the part of the component comprises a part of the loop.

6. A fastening clip for mounting a component, such as an airbag or a luggage ring, to a support structure, the fastening clip comprising:
a head portion and a body portion extending from the head portion to a lower end region along a longitudinal axis, wherein the body portion comprises at least one elastically deflectable retaining member projecting laterally from said lower end region of said body portion to fixingly engage a surface of the support structure when inserted into an orifice of the support structure; and
at least one resilient spring element extending from the head portion to contact an opposite side of the support structure to the at least one elastically deflectable retaining member in use, and to bias the at least one elastically deflectable retaining member into contact with the support structure,
wherein each of the at least one resilient spring elements comprises: a longitudinal portion extending from the head portion in a direction having a longitudinal component, and a transverse portion extending from the longitudinal portion across the longitudinal axis, and
wherein the longitudinal portion has a length in the longitudinal direction, the length being configured such that when the fastening clip is affixed to the opening in the support structure the transverse portion lies substantially parallel to the support structure in a deflected state.

7. The fastening clip of claim 6, wherein the longitudinal portion extends in a direction substantially parallel to the longitudinal axis.

8. The fastening clip of claim 7, wherein each of the at least one resilient spring elements further comprises an intermediate portion extending from the transverse portion between the transverse portion and the head portion.

9. The fastening clip of claim 8, wherein the intermediate portion comprises a tab portion extending towards the transverse portion to contact the transverse portion and limit deflection of the intermediate portion towards the transverse portion during use.

10. The fastening clip of claim 9, wherein the head portion comprises a plate adapted to retain a part of the component between the plate and the support structure during use, and wherein the intermediate portion is arranged to engage the part of the component when the at least one resilient spring element is deflected during use.
